(19) United States
(12) Patent Application Publication
(10) Pub. No.: US 2026/0243301 A1
(43) Pub. Date: Aug. 20, 2026

(54) FACILITY MODULE, CONVEYANCE MODULE, AND NON-TRANSITORY COMPUTER-READABLE STORAGE MEDIUM

(71) Applicant: THK CO., LTD., Tokyo (JP)

(72) Inventors: Shuhei Yamanaka, Tokyo (JP); Akihiro Unno, Tokyo (JP); Yusuke Omote, Tokyo (JP)

(73) Assignee: THK CO., LTD., Tokyo (JP)

(21) Appl. No.: 19/161,768

(22) PCT Filed: Mar. 5, 2024
(86) PCT No.: PCT/JP2024/008196

§ 371 Date: Sep. 3, 2025

(30) Foreign Application Priority Data
Mar. 6, 2023 (JP) 2023-034059

(51) Int. Cl. F16C 29/00

(52) U.S. Cl. CPC F16C 29/005; F16C 29/004

(57) ABSTRACT

An equipment module (1) includes a stand (11) that supports one or more transport modules (2, 12) and that is repositionable and is configured such that: the stand (11) supports the one or more transport modules (2, 12) so that part of at least one transport module (2, 12) of the one or more transport modules (2, 12) protrudes from the stand (11) in a horizontal direction; and the equipment module (1) is connected to an adjacent equipment module (1) via the at least one transport module (2) protruding from the stand (11) in the horizontal direction.

### TECHNICAL FIELD

The present invention relates to an equipment module, a transport module, and a program.

### BACKGROUND ART

Conventionally, various techniques have been proposed to enable smooth travelling of track travelling bodies even if positional shift (sideway shift) between travel rails and connection rails occurs. For example, Patent Literature 1 discloses a rail device including paired travel rails for guiding a track travelling body and a connection rail interposed between the travel rails, respective rail support mechanisms for supporting the connection rail being provided on one travel rail side and the other travel rail side of the connection rail, the connection rail being configured to be rotatable horizontally about the rail support mechanisms.

### CITATION LIST

### Patent Literature 1

Japanese Patent Application Publication Tokukai No. 2005-076290.

### SUMMARY OF INVENTION

### Technical Problem

However, the conventional technique as described above is a technique that enables handling of even a positional shift occurring afterwards. Therefore, in initial installation of transport modules for configuring a transport path, labor-intensive tasks, such as assembly and adjustment of the transport modules and the rail support mechanisms of the transport modules and coordinate corrections thereof through teaching, have needed to be carried out with high accuracy. In particular, complexity of the configuration of the support mechanisms makes installation of the mechanisms particularly troublesome.

An aspect of the present invention has been made in light of the foregoing problem, and it is an object thereof to reduce time and effort for installation by allowing minor positional shift between transport modules, without complicating the

### Solution to Problem

In order to solve the foregoing problem, an equipment module in accordance with an aspect of the present invention is an equipment module including a stand that supports one or more transport modules and that is repositionable, and is configured such that: the stand supports the one or more transport modules so that part of at least one transport module of the one or more transport modules protrudes from the stand in a horizontal direction; and the equipment module is connected to an adjacent equipment module via the at least one transport module protruding from the stand in the horizontal direction.

A transport module in accordance with another aspect of the present invention is a transport module connecting equipment modules that each include a stand which is repositionable and that include on-stand transport modules each supported by the stand that is single, the transport module being provided in a position bridging between the on-stand transport modules included in the equipment modules.

A program in accordance with another aspect of the present invention causes a computer to carry out: a first step of simulating arrangement of the equipment module; and a second step of simulating connection of the equipment modules in the longer-side direction via the at least one transport module protruding from the stand in the horizontal direction.

A storage medium in accordance with another aspect of the present invention is a computer-readable storage medium storing the aforementioned program.

### Advantageous Effects of Invention

An aspect of the present invention enables reduction of the time and effort for installation by allowing minor positional shift between transport modules, without complicating the configuration.

### BRIEF DESCRIPTION OF DRAWINGS

FIG. 1 is an example view schematically illustrating a transport system.

FIG. 2 is an example functional block diagram including members included in the transport system.

FIG. 3 is an example perspective view illustrating an on-stand transport module and a guide block included in the transport system.

FIG. 4 is an example perspective view illustrating two guide rails connected by a spacer.

FIG. 5 is an example view schematically illustrating the spacer and the guide rails as seen from a y-axis direction.

FIG. 6 is an example perspective cross-sectional view illustrating a guide block.

FIG. 7 is an example cross-sectional view illustrating the guide block taken along a plane perpendicular to a sliding direction of the guide block.

FIG. 8 is an example cross-sectional view illustrating a cyclic path inside the guide block.

FIG. 9 is an example top view illustrating the guide rails and the spacer.

FIG. 10 is an example top view illustrating a conventional transport system having guide rails connected with no spacer interposed and the transport system in accordance with the present example.

FIG. 11 is an example cross-sectional view illustrating the guide block taken along a plane parallel to the sliding direction of the guide block.

FIG. 12 is a view of example cross-sectional views illustrating guide blocks in which the number of load-bearing rolling elements becomes three to one in crossing of a level difference in a single cyclic path.

FIG. 13 is a graph showing a result of simulation carried out, on a maximum surface pressure applied to each load-bearing rolling element, for each number of the load-bearing rolling elements in crossing of a level difference.

FIG. 14 is an example cross-sectional view illustrating the guide block taken along a plane parallel to the sliding direction of the guide block.

FIG. 15 is a graph showing a relationship, for each number of the load-bearing rolling elements, between a stroke of the guide block and a sliding resistance occurring on the guide block.

FIG. 16 is an example perspective view illustrating a spacer in accordance with a variation and guide rails.

FIG. 17 is an example functional block diagram illustrating a simulation device.

FIG. 18 is an example view schematically illustrating a transport system having equipment modules connected by connecting on-stand transport modules.

### DESCRIPTION OF EMBODIMENTS

### Transport System

The following description will discuss an embodiment of a transport system in accordance with an aspect of the present invention in detail. A transport system 100 in accordance with the present embodiment causes a guide block 4 serving as a carriage to slide to transport a workpiece to be subjected to a predetermined process or measurement.

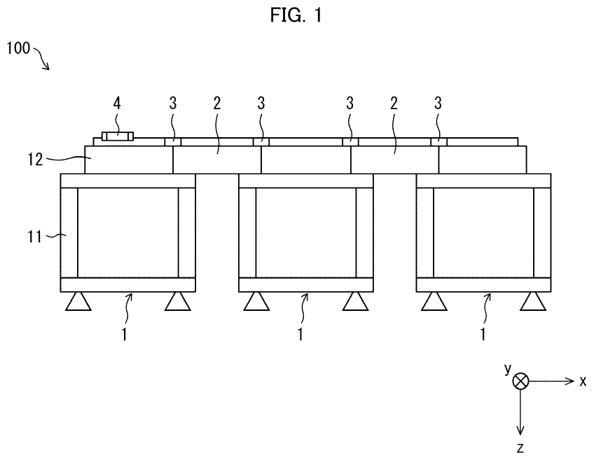

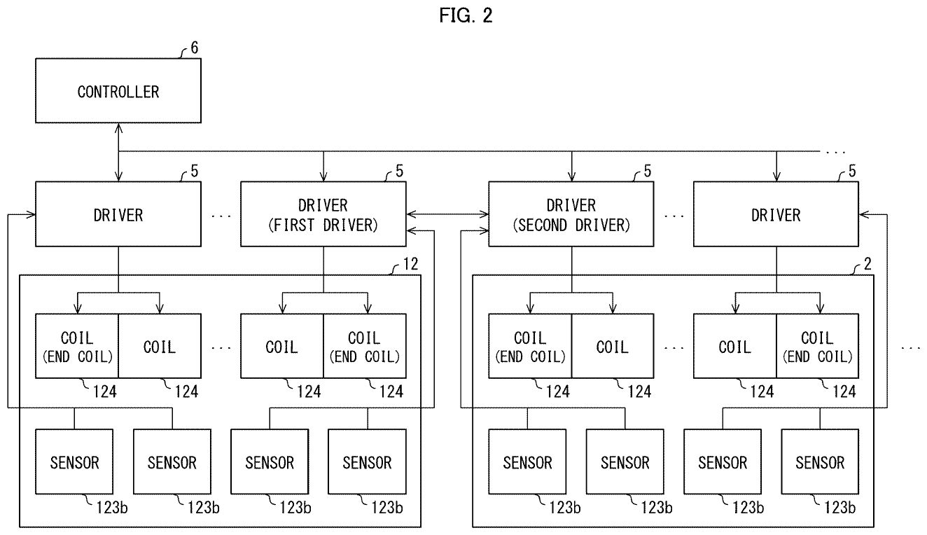

FIG. 1 is an example view schematically illustrating the transport system 100. As illustrated in FIG. 1, the transport system 100 includes a plurality of equipment modules 1, one or more linking transport modules 2 (second transport module), one or more spacers 3, and one or more guide blocks 4. FIG. 2 is an example functional block diagram including other members included in the transport system 100. As illustrated in FIG. 2, the transport system 100 further includes a plurality of drivers 5 and a controller 6. The following will describe the members included in the transport system 100 with reference to, for example, FIG. 1 and FIG. 2.

### Equipment Module

As illustrated in FIG. 1, each of the equipment modules 1 includes a stand 11 and an on-stand transport module 12 (first transport module). It is also possible that a single equipment module 1 includes a plurality of stands 11 and a plurality of on-stand transport modules 12. Further, the number of the stands 11 included in the single equipment module 1 may differ from the number of the on-stand transport modules 12 included in the single equipment module 1.

### Stand

The stands 11 each have a top face which is horizontal and flat. The stands 11 have the same height (distance in a z-axis direction from the floor surface on which the stands 11 are disposed to the top faces thereof). A device (not illustrated) is provided to at least one of the plurality of stands 11. This device carries out a predetermined process or measurement on the workpiece transported by the on-stand transport module 12 and an adjacent linking transport module 2. Typically, the stands 11 are fixed on the floor surface during operation of the transport system 100, but the stands 11 can be repositioned. This means that the equipment modules 1, the on-stand transport modules 12, linking transport modules 2, and the guide rails 122 can also be repositioned. This enables quick repositioning to a manufacturing line suitable for another product, for example, in a case where a product to be manufactured with use of the transport system 100 changes.

### On-Stand Transport Module

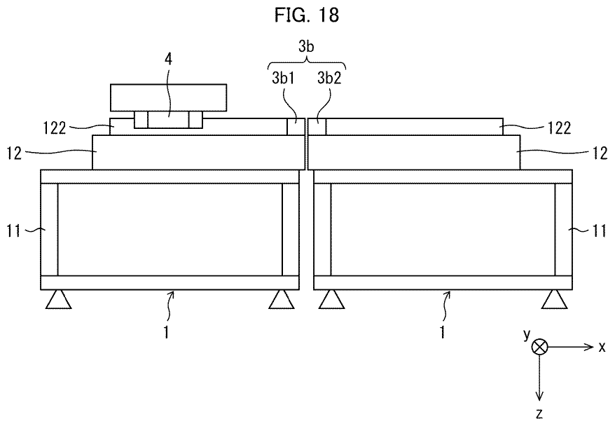

Each on-stand transport module 12 is supported by a single (integrated) stand 11. In an aspect, the on-stand transport module 12 is fixed on the top face of the stand 11 with use of fasteners, such as bolts, and the entire on-stand transport module 12 is supported by the single stand 11. However, as illustrated in FIG. 18 described later, a configuration may be employed in which part of the on-stand transport module 12 and part of a guide rail 122 protrude from a single stand 11. The on-stand transport module 12 may be bonded to the stand 11 or welded to the stand 11.

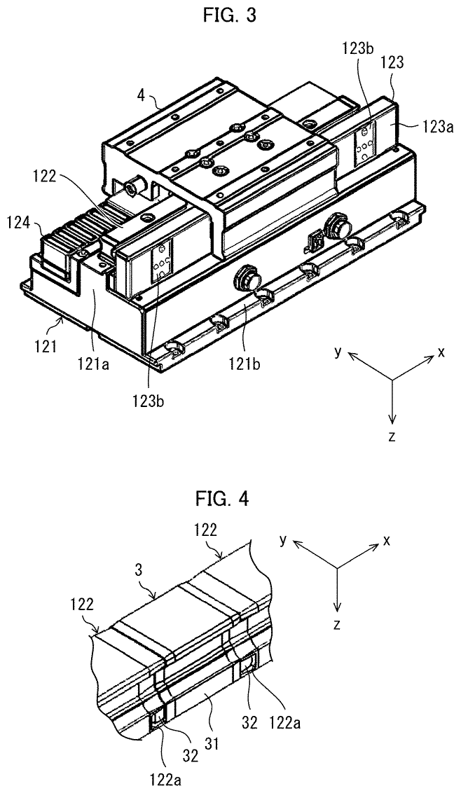

FIG. 3 is an example perspective view illustrating the on-stand transport module 12 and the guide block 4 included in the transport system 100. The on-stand transport module 12 is of a moving magnet type and includes a body 121, a guide rail 122, a sensor array 123, and a plurality of coils 124. Note that a single on-stand transport module 12 may include one coil 124.

### Body

The body 121 is a member having a rectangular shape in a plan view. A center part of the body 121 is provided with a base part 121a formed so as to extend in a longer-side direction (x-axis direction) and protrude upward (z-axis negative direction). Both end parts of the body 121 in a shorter-side direction (y-axis direction) are each provided with a fixing part 121b protruding in the shorter-side direction. Bolt holes for fixing the body 121 to the stand 11 are formed in the fixing part 121b.

### Guide Rail

Each guide rail 122 is attached on the base part 121a of the body 121 so that a longer-side direction thereof is aligned with the longer-side direction of the body 121. Typically, the guide rails 122 are made of metal. The length of the guide rail 122 in a longer-side direction is shorter than the length of the body 121 (or the base part 121a) in a longer-side direction by an amount corresponding to an area to which the spacer 3 is attached. The guide rail 122 is attached to the base part 121a so that the center thereof in the longer-side direction is aligned with the center of the body 121 (or the base part 121a) in the longer-side direction. Therefore, in both end parts, in the longer-side direction, of the top face of the base part 121a, there exists a region which has a substantially half length of the spacer body 31 and where no guide rail 122 is provided. Half of the spacer 3 for connecting the guide rails 122 is positioned in this region.

FIG. 4 is an example perspective view illustrating two guide rails 122 connected by the spacer 3. As illustrated in FIG. 4, each of the guide rails 122 has, at both end parts thereof in a longer-side direction, engaging parts 122a to be connected with the spacer 3. The engaging parts 122a in accordance with the present embodiment are recesses 122a to be connected with protrusions 32 of the spacer 3. More specifically, the recesses 122a are grooves that extend from one end to the other end of the guide rail 122 in the shorter-side direction. A configuration may be also employed in which the spacer 3 has dented recesses and the guide rail 122 has projecting protrusions as the engaging parts 122a. Further, the engaging parts 122a at both ends of the guide rail 122 may have different shapes at one end and the other end. For example, one of them may be a recess and the other of them may be a protrusion. The protrusions or the recesses may be provided also in a component (e.g., body 121) of the on-stand transport module 12 other than the guide rail 122.

### Sensor Array

As illustrated in FIG. 3, the sensor array 123 includes a support member 123a and a plurality of sensors 123b. The support member 123a has a rectangular rod shape and is provided alongside the guide rail 122. The plurality of sensors 123b are disposed so as to be arranged at predetermined intervals along a longer-side direction, on a side face of the support member 123a which faces away from the side face thereof facing the guide rail 122 (which faces in a y-axis negative direction). The sensors 123b read a scale included in the guide block 4 when the guide block 4 slides in a longer-side direction of the on-stand transport module 12 including the sensors 123b. The scale is provided at a position, on the wall surface inside the guide block 4, which faces the sensors 123b. The sensor array 123 may include one sensor 123b. The sensors 123b may be attached to, for example, the base part 121a of the body 121. In that case, the sensor array 123 may not include the support member 123a.

### Coil

The plurality of coils 124 are provided alongside the guide rail 122. Specifically, the plurality of coils 124 are attached to one side of the body 121 in the shorter-side direction so as to be arranged along the longer-side direction of the guide rail 122. As illustrated in FIG. 2, the plurality of coils 124 are associated with the drivers 5 for controlling power supplied to the coils 124. The coils 124 are classified into a plurality of groups, and a single driver 5 is associated with one or more coils 124 included in each group. The number of the coils 124 associated with a single driver 5 may be two as illustrated in FIG. 2, or may be one, or may be three or more. Since the plurality of coils 124 are arranged in one row, there exists a coil 124 that faces an adjacent linking transport module 2 side (that is arranged at the very end), among the plurality of coils 124. Hereinafter, this coil 124 may be referred to as “end coil 124”. Further, among the plurality of drivers 5, a driver 5 associated with the end coil 124 may be referred to as “first driver 5”. The plurality of coils 124 generate a magnetic field for sliding the guide block 4, on the basis of control by the drivers 5. All of the coils 124 included in a single on-stand transport module 12 may be associated with a single driver 5.

### Linking Transport Module

As illustrated in FIG. 1, the linking transport module 2 is provided in a position bridging between the on-stand transport module 12 included in an equipment module 1 and the on-stand transport module 12 included in an equipment module 1 adjacent to the equipment module 1. This enables the linking transport module 2 to connect the equipment modules 1. The linking transport module 2 is configured as in the case of the on-stand transport module 12, except its arrangement. That is, the linking transport module 2 includes the body 121, the guide rail 122, the sensor array 123 and the plurality of coils 124, or members corresponding to these. Therefore, the end coil 124 facing an on-stand transport module 12 side exists also on the linking transport module 2. Hereinafter, among the plurality of drivers 5, a driver 5 associated with an end coil 124 of the linking transport module 2 may be referred to as “second driver 5”.

### Spacer

As illustrated in FIG. 1, the spacer 3 is attached between the on-stand transport module 12 and the linking transport module 2. Specifically, the spacer 3 is provided across a top face of an end part of the base part 121a of the on-stand transport module 12 and a top face of an end part of the base part 121a of the linking transport module 2, and connects the guide rails 122 at both the ends. The spacer does not necessarily need to be provided across the modules, and the end face of the spacer may be positioned at the surface of one of the modules.

In an aspect, the spacer 3 is made of resin, but may be made of another material. The fact that the spacer 3 is made of resin enables the production thereof to be carried out inexpensively and easily. The spacer 3 includes a spacer body 31 and engaged parts 32.

As illustrated in FIG. 4, an outline of the spacer 3 as seen from a direction in which the spacer 3 is attached (y-axis direction) and an outline of the guide rail 122 as seen from the same direction coincide at a boundary surface. Further, the length of the spacer body 31 in an x-axis direction may be slightly shorter, for example, by approximately 0.2 mm, the distance from an end face of the guide rail 122 of the on-stand transport module 12 to an end face of the guide rail 122 of the linking transport module 2. This is to facilitate the change in inclination of the spacer 3, as described later.

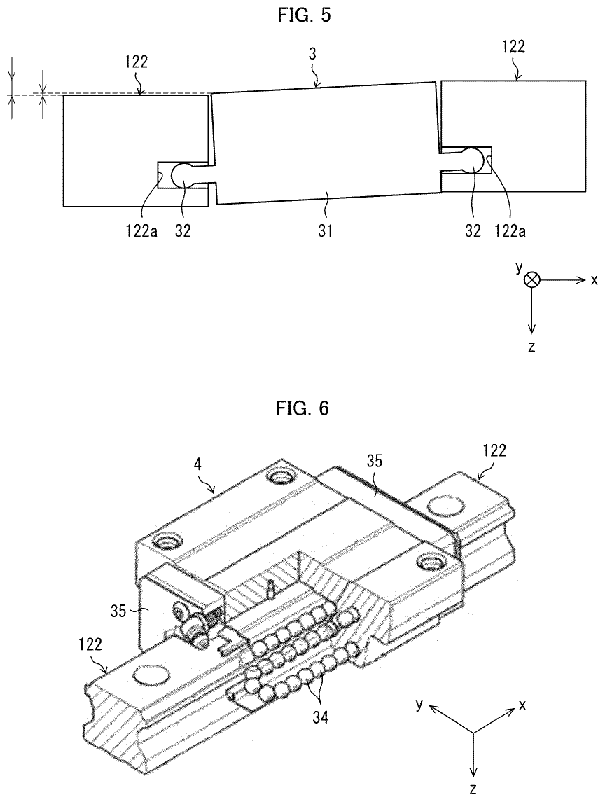

The engaged parts 32 are provided at both ends of the spacer body 31 which come into contact with the guide rails 122. The engaged parts 32 in accordance with the present embodiment are protrusions 32 to be connected with the recesses 122a of the on-stand transport module 12 or the transport module 2. The spacer 3 connects, in a longer-side direction, the on-stand transport module 12 and the linking transport module 2 that are adjacent to each other. As illustrated in FIG. 5 described later, the vertical width of the base end part of the protrusion 32 is narrower than that of the tip end part thereof. Therefore, a gap is formed between the base end part of the protrusion 32 engaged with the recess 122a and the recess 122a, so that the inclination of the spacer 3 can change. It is also possible that the engaged parts 32 are recesses to be connected with protrusions of the on-stand transport modules 12 or the transport modules 2. Further, the engaged parts 32 at the both ends may have different shapes at one end and the other end.

### Connection of Equipment Modules

The equipment modules 1 are arranged in one row at predetermined intervals so that the longer-side direction of the guide rails 122 is aligned with the direction in which the equipment modules 1 are arranged. The predetermined interval is a length that does not exceed a length of a single linking transport module 2 in a longer-side direction. The lengths of the on-stand transport modules 12 and the lengths of the linking transport modules 2 may not be uniform. The equipment module 1 is connected to an adjacent equipment module 1 via the linking transport module 2. The linking transport module 2 may be configured to be fixed, at both ends thereof in a longer-side direction, to the stands 11 at both ends between which to bridge, with use of fasteners, such as bolts.

In a case where a configuration is employed in which the modules corresponding to the equipment modules 1 (or the on-stand transport modules 12) are connected to each other with no linking transport module 2 interposed, it is necessary to accurately align the heights of the stands, and this may lead to much time and effort to make the stands horizontal and to adjust the heights. In addition, a significant difference in the required time for this operation may arise depending on the skill level of the installer, resulting in difficulty in carrying out planned operation. In contrast, according to the configuration in accordance with the present embodiment in which the equipment modules 1 are connected to each other via the linking transport module 2, minor positional shift between the stands 11 can be absorbed and alleviated by the linking transport module 2. This enables reduction of the time and effort for installation by allowing minor positional shift between the on-stand transport modules 12 of the equipment modules 1, without complicating the configuration.

The on-stand transport module 12 is connected to an adjacent linking transport module 2 in a longer-side direction via the spacer 3. More specifically, the guide rail 122 of the on-stand transport module 12 is connected to the guide rail 122 of the adjacent linking transport module 2 in a longer-side direction via the spacer 3. In this case, the on-stand transport module 12 and the linking transport module 2 are connected via the spacer 3 which is attachable and detachable while the transport modules 12 and 2 are in a fixed state. As described above, the engaging parts 122a of the guide rail 122 are grooves extending from one end to the other end of the guide rail 122 in a shorter-side direction. Therefore, to the on-stand transport modules 12, the spacer 3 is attachable and detachable merely by passing the engaged parts 32 (protrusions 32) thereof laterally through the grooves in a position between the on-stand transport module 12 and the adjacent on-stand transport module 12 that are in a fixed state.

In many cases, the spacer 3 reaches the end of its lifespan earlier than the guide rail 122, and thus the foregoing configuration in which the spacer 3 is replaceable without moving the guide rails 122 greatly contributes to improving user convenience.

The plurality of equipment modules 1 (or the on-stand transport modules 12) connected by the linking transport module 2 and the spacer 3 can be repositioned. In other words, even when the spacer 3 and the linking transport module 2 are removed from the plurality of equipment modules 1 that have been disposed, and the arrangement order of the equipment modules 1 is changed, followed by connecting the equipment modules 1 again with use of the linking transport module 2 and the spacer 3, they function as the transport system 100 corresponding to the arrangement order.

As described above, the length of the spacer body 31 in an x-axis direction may be slightly shorter than the distance from an end face of the guide rail 122 of the on-stand transport module 12 to an end face of the guide rail 122 of the linking transport module 2. Therefore, a small gap is formed between the guide rail 122 and the spacer body 31. Further, the inclination of the spacer 3 can change while the spacer 3 is connected to the guide rail 122. Therefore, the spacer 3, while connecting the on-stand transport module 12 and the linking transport module 2, can assume inclination corresponding to a relationship between a height of the guide rail 122 of the on-stand transport module 12 and a height of the guide rail 122 of the linking transport module 2.

In a case where there is no difference between the height of the guide rail 122 of the on-stand transport module 12 and the height of the guide rail 122 of the linking transport module 2, the top face of the spacer 3 is flush with the top face of each guide rail 122 and is horizontal.

FIG. 5 is an example view schematically illustrating the spacer 3 and the guide rails 122 as seen from a y-axis direction. As illustrated in FIG. 5, in a case where there is a difference between the heights of the guide rails 122, the top face of the spacer 3 is inclined so that the height of one end thereof substantially coincides with the height of the top face of the lower guide rail 122, and the height of the other end substantially coincides with the height of the top face of the higher guide rail 122. This reduces the difference between the height of the top face of each guide rail 122 and the height of the top face of the spacer 3 to approximately 1/10 of the difference between the heights of the top faces of the guide rails 122.

In a broad sense, the spacer 3 is provided so that a first face (e.g., top face) of the spacer 3 is directed in a direction from an end part of a first face of a first guide rail 122 to an end part of a first face of a second guide rail 122 adjacent thereto, and a second face (e.g., bottom face) of the spacer 3 is directed in a direction from an end part of a second face of the first guide rail 122 to an end part of a second face of the second guide rail 122. Here, the first faces of the members are all located on the same side, and the same applied to the second faces.

In addition, the first face and the second face of each of the spacer 3, the first guide rail 122, and the second guide rail 122 are opposite faces thereof. That is, the first face and the second face are one and the other of the top and bottom faces or one and the other of the side faces.

From a different perspective, it can be said that the spacer 3 is attachable to the first guide rail 122 and the second guide rail 122 so as to allow the spacer 3 to absorb a positional error in a direction orthogonal to a direction in which the guide rails 122 are connected, that is, to connect end parts of the guide rails 122 that may exhibit positional shift.

As illustrated in FIG. 5 as an example, the recesses 122a of the guide rails 122 and the protrusions 32 of the spacer 3 may not be positioned at the center of the guide rails 122 in a z-axis direction. By manufacturing the guide rails 122 and the spacer 3 with these positions shifted from the center, it is possible to adjust the range within which the spacer 3 can incline. The same applies to the case where the guide rail 122 has protrusions and the spacer 3 has recesses.

### Guide Block

The guide block 4 slides on the guide rails 122 in the longer-side direction of the guide rails 122. As described above, the on-stand transport module 12 is connected to an adjacent linking transport module 2 in a longer-side direction via the spacer 3. Therefore, the guide block 4 is slidable also between the guide rail 122 of the on-stand transport module 12 and the guide rail 122 of the adjacent linking transport module 2. As described above, since the on-stand transport module 12 in accordance with the present embodiment is of a moving magnet type, the guide block 4 is accordingly configured to correspond to the moving magnet type. That is, the guide block 4 includes a magnet (not illustrated) and the scale described above. The attractive force or repulsive force generated between this magnet and the coils 124 of the on-stand transport module 12 or the linking transport module 2 moves the guide block 4.

In many cases, a table on which a workpiece is to be placed is attached on the guide block 4. Further, a single transport system 100 may include a plurality of guide blocks 4, and a configuration may be employed in which a single table is attached to the plurality of guide blocks 4.

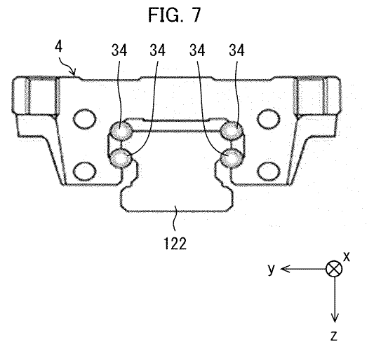

FIG. 6 is an example perspective cross-sectional view illustrating the guide block 4. FIG. 7 is an example cross-sectional view illustrating the guide block 4 taken along a plane perpendicular to a direction in which the guide block 4 slides. In FIG. 6 and FIG. 7, the sensor array 123 and the like are not illustrated. As described in FIG. 6 and FIG. 7, a plurality of rolling elements (balls) 34 are disposed in the cyclic path inside the guide block 4. End caps 35 are members positioned at both ends of the guide block 4 in an x-axis direction and containing curved portions of the cyclic path. A ball retainer may be provided between the respective rolling elements 34. Further, with the guide rail 122, only the rolling elements 34 are in contact, and the frame of the guide block 4 is not in contact. Further, when the guide block 4 slides, the rolling elements 34 circulate in the cyclic path, thereby making it possible to greatly reduce friction with the guide rail 122.

The cyclic path includes a load-bearing region where a pressure is applied from the guide rail 122 or the spacer 3 to the rolling elements 34 and a load-free region where no pressure is applied from the guide rail 122 or the spacer 3 to the rolling elements 34. Contact of the rolling elements 34 with the guide rail 122 or the spacer 3 does not necessarily mean that a pressure is applied from the guide rail 122 to the rolling elements 34, that is, does not necessarily mean that the rolling elements 34 are positioned in the load-bearing region, whereas the rolling elements positioned in the load-bearing region are always in contact with the guide rails 122 or the spacer 3. The load-bearing region and load-free region each have a range corresponding to the shapes of the guide rail 122, the spacer 3, and the guide block 4. From a different perspective, the ranges of the load-bearing region and load-free region may vary depending on the position of the guide block 4 relative to the guide rail 122 and the spacer 3.

### Driver

The plurality of drivers 5 control power supplied to the coils 124, on the basis of instruction from the controller 6. Further, among the plurality of drivers 5, a first driver 5 (driver 5 associated with an end coil 124 of the on-stand transport module 12) transmits information on a position or velocity of the guide block 4 to a second driver 5 (driver 5 associated with an end coil 124 of the linking transport module 2). Here, the first driver 5 generates information on a position or velocity of the guide block 4 on the basis of information obtained from the sensors 123b associated with the first driver 5, and, for example, when the guide block 4 slides from a position on the on-stand transport module 12 to a position on an adjacent linking transport module 2, the first driver 5 transmits the information to the second driver 5.

Further, among the plurality of drivers 5, a second driver 5 controls power supplied to coils 124 facing an end coil 124 side among the one or more coils 124 included in a linking transport module 2 adjacent to the on-stand transport module 12. The second driver 5 transmits information on a position or velocity of the guide block 4 to the first driver 5. Here, the second driver 5 generates information on a position or velocity of the guide block 4 on the basis of information obtained from the sensors 123b associated with the second driver 5, and, for example, when the guide block 4 slides from a position on the linking transport module 2 to a position on an adjacent on-stand transport module 12, the second driver 5 transmits the information to the first driver 5.

The first driver 5 and the second driver 5 may transmit and receive, to and from each other, for example, information on a value of the power supplied to one of the coils 124 or other information used to calculate the power value. In an aspect, LINK communication is used for communication between the first driver 5 and the second driver 5, and SYNC communication is used for communication between the controller 6 and the drivers 5.

### Operation of Transport System

In the transport system 100, when the controller 6 controls the drivers 5, for example, the first driver 5 supplies power to the coils 124 of the on-stand transport module 12 at a specific timing, and the second driver 5 supplies power to the coils 124 of the linking transport module 2 at a specific timing. This causes the guide block 4 to slide on the guide rails 122 in the longer-side direction of the guide rails 122.

Further, when the guide block 4 moves between the on-stand transport module 12 and the linking transport module 2, the guide block 4 slides also on the spacer 3. In this case, in a case where there exists no level difference between the surface of the guide rail 122 of the on-stand transport module 12 and the corresponding surface of the guide rail 122 of the linking transport module 2, the spacer 3 does not move even when the guide block 4 slides on the spacer 3. Here, the “level difference” above refers to a shift between positions of adjacent guide rails 122 in a y-axis direction or z-axis direction.

On the other hand, in a case where there exists a level difference between the surfaces of the two guide rails 122, the inclination of the spacer 3 changes in a specific range in any one direction in accordance with the sliding of the guide block 4.

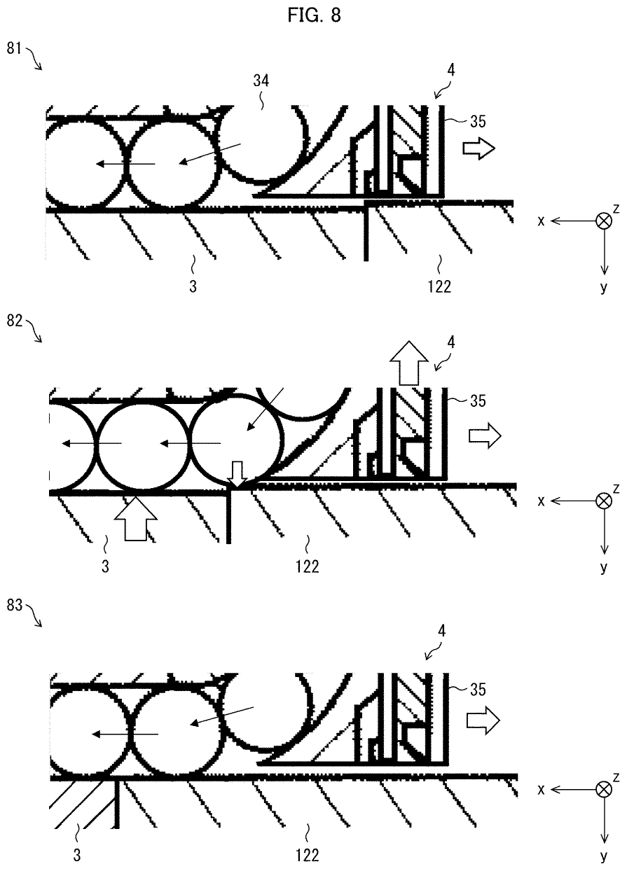

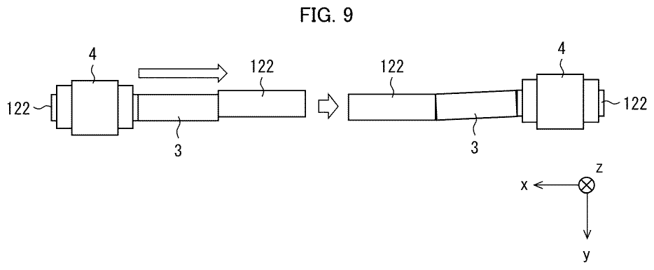

FIG. 8 is an example cross-sectional view illustrating the cyclic path inside the guide block 4. The rolling elements 34 illustrated in FIG. 8 as an example correspond to the rolling elements 34 illustrated in the upper right of FIG. 7. For example, in a case where there exists no level difference between the surface of the first guide rail 122 on which the guide block 4 is sliding and the side face of the spacer 3 connected ahead of the first guide rail 122, and the surface of the second guide rail 122 connected ahead of the spacer 3 forms a level difference so as to protrude laterally (e.g., in the y-axis negative direction) from the surface of the spacer 3, the guide block 4 moves from the first guide rail 122 to the spacer 3 without moving the spacer 3. Thereafter, as illustrated in the cross-sectional view 81 of FIG. 8, when entering the level difference at the second guide rail 122, the second guide rail 122 passes by a side (y-axis positive direction) of the end cap 35. Subsequently, as illustrated in the cross-sectional view 82 of FIG. 8, a rolling element 34 which is circulating in the cyclic path and is about to come into contact with the second guide rail 122 collides with a level difference formed by the second guide rail 122. At that time, due to a reaction force of a force applied by the rolling element 34 to the level difference, the front end part of the guide block 4 is pressed in a direction away from the side face of the guide rail 122 (pressed in a y-axis negative direction). Further, the side face of the spacer 3 on an opposite side from the side face illustrated in FIG. 8 is accordingly pushed by the rolling elements 34 in contact with the side face of the guide block 4 on the opposite side. With these actions, as illustrated in the cross-sectional view 83 of FIG. 8, the tip end part of the guide block 4 changes direction toward a y-axis negative direction together with the spacer 3, so that the level difference between the side face of the spacer 3 and the side face of the second guide rail 122 ahead becomes smaller. Therefore, as illustrated in FIG. 9, the guide block 4 can smoothly move from the spacer 3 to the guide rail 122. This FIG. 9 is an example top view illustrating the guide rails 122 and the spacer 3. In FIG. 9, the level difference between the guide rails 122 is illustrated to be exaggeratedly large to facilitate understanding.

FIG. 9 shows that the inclination of the spacer 3 is changeable around the z axis as a rotation axis and that the change of the inclination of the spacer 3 made when the guide block 4 slides on the spacer 3 alleviates the level difference between the guide rails 122 in the y-axis direction.

As described above, FIG. 5 shows that the spacer 3 alleviates the level difference in the z-axis direction between the guide rails 122. Here, the inclination of the spacer 3 is changeable around the y axis as a rotation axis. That is, in a case where an external pressure is applied to the spacer 3, such as a case where the guide block 4 slides on the spacer 3, the inclination of the spacer 3 may change in a specific range in one or both of a direction around the z axis as a rotation axis and a direction around the y axis as a rotation axis.

Note that the inclination of the spacer 3 does not necessarily change when the guide block 4 slides on the spacer 3.

### Effects of Transport Module and Transport System

As described above, the on-stand transport module 12 and the linking transport module 2 make it possible to configure the transport system 100 while allowing minor positional shift between the guide rails 122 so as to reduce the time and effort for installation and not complicating the configuration. This transport system 100 makes it possible to alleviate an impact applied to the guide block 4 when the guide block 4 slides between the on-stand transport module 12 and the linking transport module 2.

### Operation Examples in Crossing of Level Difference

The following will describe one example of operation carried out when the guide block 4 crosses a level difference between the guide rail 122 and the spacer 3. The configuration represented by the following conditions is used in the present example.
Radial load: 3000 [N]
Level difference (horizontal): 0.1 [mm]
Level difference (vertical): 0.1 [mm]

Here, the “radial load” refers to a load applied from above (z-axis negative direction) to the guide block 4. The “level difference (horizontal)” refers to a shift between positions of the guide rail 122 and the spacer 3 in a y direction, and the expression “level difference (vertical)” refers to a shift between positions of the guide rail 122 and the spacer 3 in a z direction. Further, a gap (clearance) of 0.1 mm exists between the guide rail 122 and the spacer body 31.

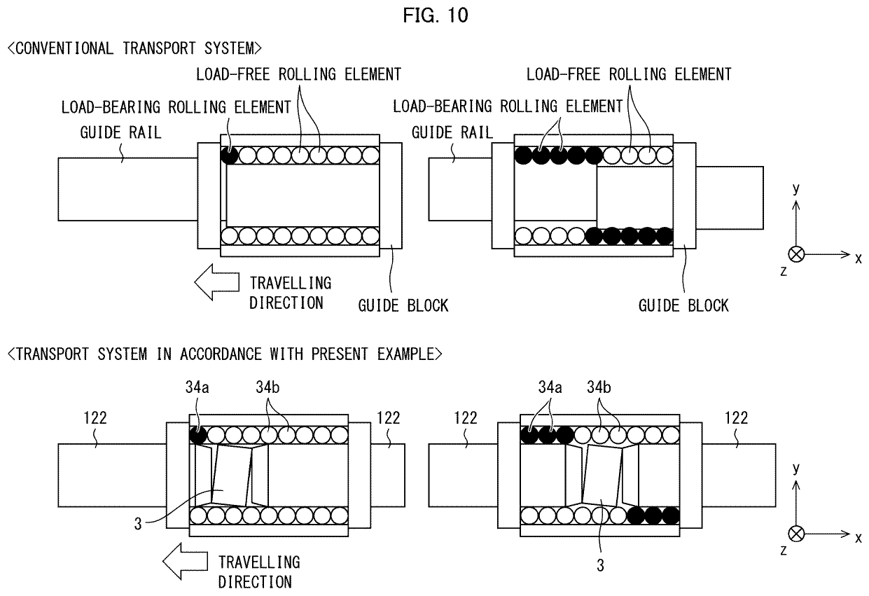

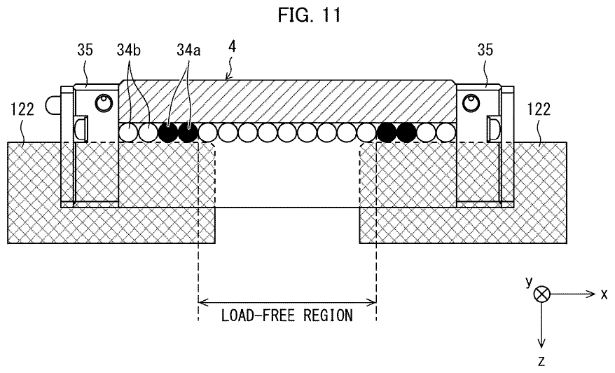

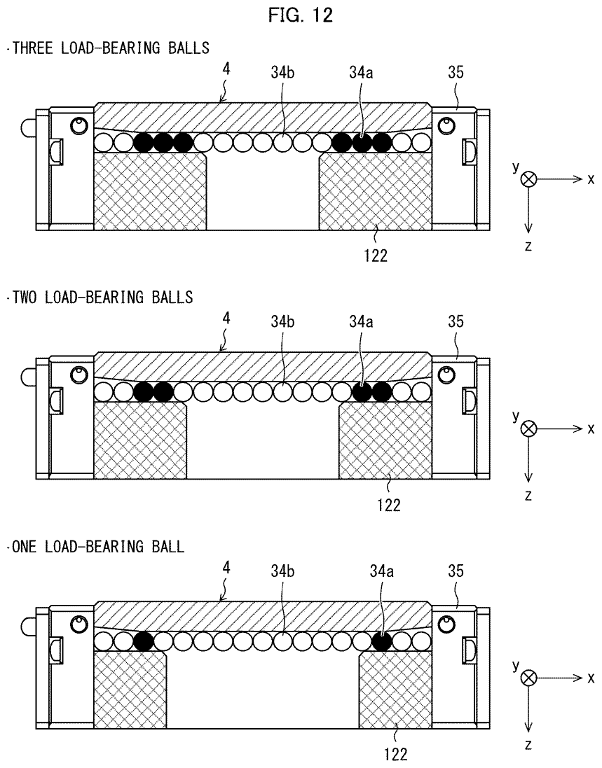

FIG. 10 is an example top view illustrating a conventional transport system having guide rails 122 connected with no spacer 3 interposed and the transport system 100 in accordance with the present example. In FIG. 10, and FIGS. 11 and 12 described later, the load-bearing rolling element 34a shown in black indicates a rolling element 34 located in the load-bearing region, and the load-free rolling element 34b shown in white indicates a rolling element 34 located in the load-free region.

In the conventional transport system, a level difference between the guide rails is large, and collision of a rolling element with the level difference applies a great load to the rolling element, resulting in steep increase in resistance against the sliding. This precludes smooth operation. In contrast, the transport system 100 in accordance with the present example has the guide rails 122 connected via the spacer 3, thereby making a level difference smooth. This makes it possible to mitigate a load applied to the rolling elements 34. This makes it possible to reduce an impact applied when the guide block 4 slides between the guide rails 122 and prevent the guide rails 122 and the guide block 4 from being worn and damaged.

FIG. 11 is an example cross-sectional view illustrating the guide block 4 taken along a plane parallel to the sliding direction of the guide block 4. Further, the spacer 3 positioned between the guide rails 122 is not illustrated. On the spacer 3, no pressure is applied to the rolling elements 34 except at level difference portions between the spacer 3 and the guide rails 122. FIG. 11 illustrates the load-bearing rolling elements 34a positioned in the cyclic path on the near side in the y-axis direction and the load-bearing rolling elements 34a positioned in the cyclic path on the far side in the y-axis direction. As illustrated in the top view of FIG. 10, these load-bearing rolling elements 34a on the near and far sides are located closer to respective diagonal directions of the guide block 4.

That is, in FIG. 11, two load-bearing rolling elements 34a exist at a position of the level difference in a single cyclic path. The configuration is employed in which when the guide block 4 slides on the spacer 3, the number of the load-bearing rolling elements 34a is reduced at least temporarily to be smaller than when the entire guide block 4 slides on a single guide rail 122, so that the load applied to the guide rail 122 and the rolling elements 34 and the sliding resistance can be reduced.

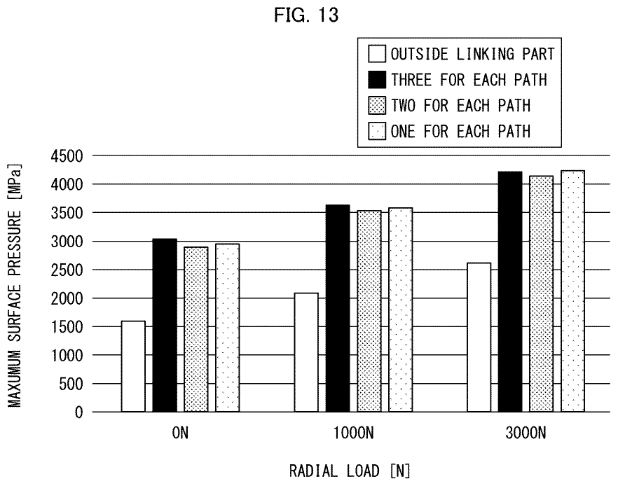

FIG. 12 is example cross-sectional views illustrating guide blocks 4 in which the number of load-bearing rolling elements 34a becomes three to one in crossing of a level difference, in a single cyclic path. FIG. 13 is a graph showing a result of simulation carried out, on a maximum surface pressure applied to each load-bearing rolling element 34a, for each number of the load-bearing rolling elements 34a in crossing of a level difference. The expression “outside linking part” in FIG. 13 refers to a surface pressure applied when the entire guide block 4 slides on a single guide rail 122.

As illustrated in FIG. 13, any number of the load-bearing rolling elements 34a exhibited a surface pressure higher than “outside linking part”. This means that when the guide block 4 crossed a level difference, a high surface pressure was temporarily applied to the rolling elements 34. In any of the cases where the radial loads were 0 N, 1000 N, and 3000 N, the value of the surface pressure became lowest in a case where the number of the load-bearing rolling elements 34a in a single cyclic path was reduced to two at least temporarily when the guide block 4 slid on the spacer 3. This means that the configuration in which the number of the load-bearing rolling elements 34a becomes two when the guide block 4 crosses a level difference reduces, to the greatest extent, the load applied to the guide rails 122 and the rolling elements 34.

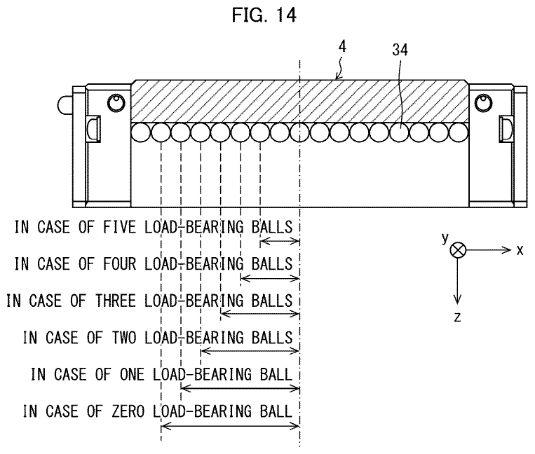

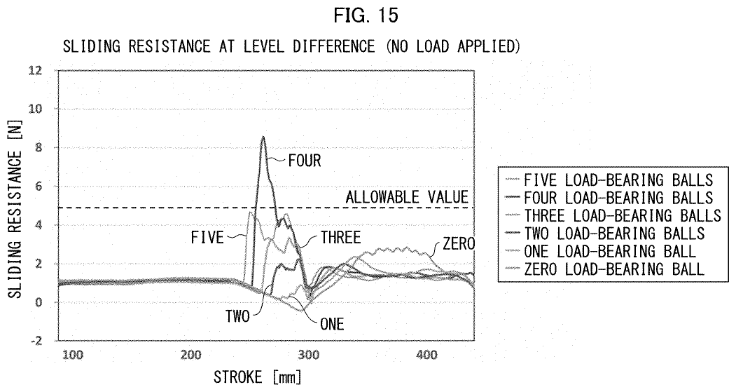

FIG. 14 is an example cross-sectional view illustrating the guide block 4 taken along a plane parallel to the sliding direction of the guide block 4. FIG. 14 further illustrates a distance between the center of the guide block 4 in the x-axis direction and the closest load-bearing rolling element 34a, for each number of the load-bearing rolling elements (load-bearing balls) 34 in the level difference crossing of the guide block 4. FIG. 15 is a graph showing a relationship, for each number of the load-bearing rolling elements 34a, between a stroke of the guide block and a sliding resistance occurring on the guide block 4. The smaller the value of this sliding resistance is, the more smoothly the guide block 4 can slide.

The value of the sliding resistance illustrated in the graph of FIG. 15 is a value obtained when no workpiece was placed on the guide block 4. As illustrated in FIG. 15, the value of the sliding resistance exceeded the allowable value in a case where the number of the load-bearing rolling elements 34a was four, and the sliding resistance became particularly small in a case where the number was 0 to 2. As described above, the value of the sliding resistance changes by changing the number of the load-bearing rolling elements 34a, and there is a tendency that an increased number of the load-bearing rolling elements 34a leads to a larger value of the sliding resistance in crossing of the level difference. Considering the results shown in the graph of FIG. 15 together with the results shown in the graph of FIG. 13, it can be said that the configuration in which the number of the load-bearing rolling elements 34a in a single cyclic path is reduced to two when the guide block 4 crosses the level difference produces a smaller load on the guide rail 122 and the rolling elements 34 and a smaller sliding resistance, thus providing significant advantages.

### Variations

The transport system 100 may not include the stands 11. For example, the on-stand transport modules 12 may be disposed directly on the floor surface.

Some or all of the stands 11 may be in contact with an adjacent stand 11.

The transport system 100 may be of the moving coil type. That is, the on-stand transport module 12 and the linking transport module 2 may include magnets, and the guide block 4 may include coils associated with the drivers 5.

Further, a configuration may be employed in which on the stands 11 that are arranged in one row, the on-stand transport modules 12 and the linking transport modules 2 are arranged in two or more rows. Also in the above configuration, the transport modules are connected by the spacer 3.

For example, some or all of the guide rails 122 of the on-stand transport modules 12 and the linking transport modules 2 and the coils 124 provided alongside the guide rails 122 are not limited to linear shapes, and may have curved shapes. The on-stand transport modules 12 and the linking transport modules 2 may constitute an annular transport path.

Some or all of the on-stand transport modules 12 may be directly connected to an adjacent on-stand transport module 12 via the spacer 3, without necessarily interposing the linking transport module 2 therebetween.

FIG. 18 is an example view schematically illustrating a transport system having the equipment modules 1 connected by connecting the on-stand transport modules 12. In FIG. 18, the on-stand transport modules 12 are connected via a spacer 3b which is dividable into a plurality of components, but the on-stand transport modules 12 may be connected via the spacer 3 or the spacer 3a described later. The spacer 3b will be described later in detail.

With the configuration illustrated in FIG. 18, part of each on-stand transport module 12 protrudes in a horizontal direction, from the stand 11 supporting the on-stand transport module 12, and the equipment modules 1 are connected via these protruding on-stand transport modules 12.

Further, with the configuration illustrated in FIG. 18, the on-stand transport modules 12 connected to each other both protrude in a horizontal direction from the respective stands 11. However, a configuration may be employed in which one of the on-stand transport modules 12 protrudes from the stand 11, and the other of the on-stand transport modules 12 is positioned up to the edge of the stand 11, not protruding. It can be said that a transport module protruding from one stand 11 in a horizontal direction and bridging between the one stand 11 and an adjacent stand 11 serves as the linking transport module 2. Therefore, it is also possible that one stand 11 does not support the on-stand transport module 12 and supports only the linking transport module 2.

In addition, a linking transport module 2 that is not supported by any stand 11 may be connected between the on-stand transport modules 12 illustrated in FIG. 18. From a different perspective, the linking transport modules 2 may include one supported by the plurality of stands 11 and one not supported by any stand 11.

As described above, the equipment modules 1 illustrated in FIG. 1 and FIG. 18 each include the stand 11 that supports one or more transport modules and that can be repositioned. In addition, in the equipment modules 1, the stands 11 support the transport modules so that part of at least one of the transport modules protrudes from the stand 11 in a horizontal direction, and the equipment module 1 is connected to an adjacent equipment module 1 via the transport module protruding from the stand 11 in a horizontal direction.

### Variation 1 of Spacer

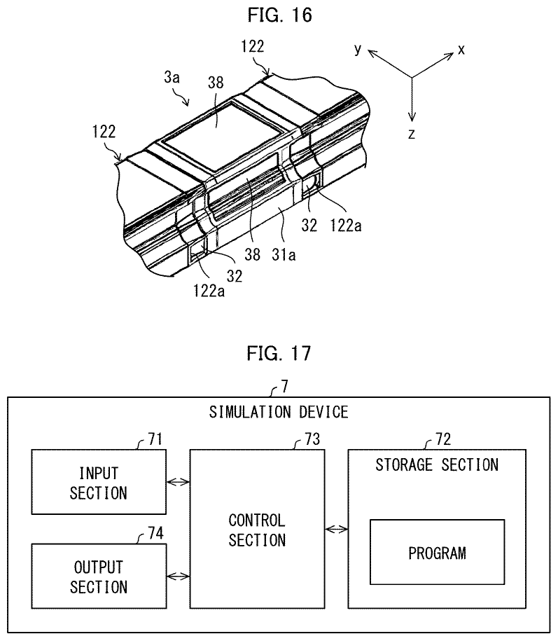

The following will describe a variation of a configuration of the spacer. Note that, for convenience, an identical reference numeral will be given to a member having a function identical to that of a member described above, and description of the member will be omitted. FIG. 16 is an example perspective view illustrating a spacer 3a in accordance with the present variation and the guide rails 122. As illustrated in FIG. 16, the spacer 3a includes a spacer body (frame part) 31a and an impregnation part 38. In an aspect, in the spacer 3a, which is made of resin, the impregnation part 38 is made of sintered resin, and the impregnation part 38 can be impregnated with lubricant. It is not essential that the spacer 3a be made of resin, and the impregnation part 38 may be made of another material that can be impregnated with lubricant and has rigidity.

The impregnation part 38 is positioned at a surface that comes into contact with the rolling elements 34 inside the guide block 4 when the guide block 4 slides on the spacer 3a. The rolling elements 34 come into contact with the impregnation part 38 impregnated with lubricant which is in turn supplied to the surfaces of the rolling elements 34.

The spacer 3a has a nested structure. In a state in which the spacer 3a is attached between adjacent guide rails 122, it is possible to attach and detach the impregnation part 38 alone with the spacer body 31a kept attached. In a broad sense, part of the spacer 3a which includes the impregnation part 38 is attachable and detachable alone. In impregnating the impregnation part 38 with lubricant, it is not essential to detach the impregnation part 38 and also it is not essential to stop a motion guide device.

According to the configuration of the spacer 3a, it is possible to constantly supply the lubricant to the guide block 4. In addition, it is not necessary to extend the entire length of the sliding part, including the guide block 4, and it is not necessary to attach another member for sliding on the guide rails 122 to supply lubricant.

Also for the spacer 3a, the configuration may be employed in which the spacer 3a has recesses and the guide rail 122 has protrusions as the engaging parts 122a.

### Variation 2 of Spacer

The spacer may be configured to be able to dividable into a plurality of components in the sliding direction of the guide block 4. The same applies to the case of including the impregnation part 38 like the spacer 3a described above.

The spacer 3b illustrated in FIG. 18 is one example of a spacer dividable into a component 3b1 and a component 3b2. From a different perspective, the spacer 3b includes a plurality of components into which the spacer 3b is dividable in the sliding direction of the guide block 4. The spacer 3b may be divided into three or more components, and the shape of a joint for integrating the components is not limited. According to the configuration of the spacer 3b, for example, each component constituting the spacer 3b can be associated with any single guide rail 122.

### Embodiment of Simulation Device

The following will describe an embodiment of a simulation device 7 in accordance with another aspect of the present disclosure in detail.

FIG. 17 is an example functional block diagram illustrating the simulation device 7. The simulation device 7 is a device configured to simulate arrangement and connection of the members included in the transport system 100. The simulation device 7 is implemented as a computer, such as PCs or mobile terminals. As illustrated in FIG. 17, the simulation device 7 includes an input section 71, a storage section 72, a control section 73, and an output section 74.

### Input Section

The input section 71, which is an interface for inputting data to the simulation device 7, is implemented by, for example, a keyboard, mouse, or button. For example, the input section 71 receives input of simulation conditions. The input section 71 may be constituted by the interface described above, or may be, for example, a communication module that receives simulation conditions from another device, or a drive that reads simulation conditions from a media.

### Storage Section

The storage section 72, which is a device that stores a variety of information, stores a program used for the simulation described later. The program is for causing a computer to carry out, for example, processes of the steps described later. The program may be stored in one or more non-transitory computer-readable storage media. In this case, the one or more storage media may or may not be provided to the simulation device 7. In the latter case, the program may be supplied to or made available to the simulation device 7 via any wired or wireless transmission medium.

### Control Section

The control section 73, which is a control device that controls the entire simulation device 7, is implemented, for example, as a processor. The control section 73 carries out processes of the following equipment module disposing step and linking transport module disposing step in accordance with the program stored in the storage section 72. The control section 73 may carry out at least any one of: a simulation of the equipment module disposing step and the linking transport module disposing step; and some simulations included in these steps, on a two-dimensional or three-dimensional virtual space. In other words, the program may be for carrying out the at least any one of the aforementioned simulations on a virtual space. The virtual space may simulate the interior of a facility such as a factory where the transport system 100 is provided.

### Equipment Module Disposing Step

In the equipment module disposing step, the control section 73 simulates arrangement of the equipment modules 1. In the present step, the control section 73 may simulate arrangement of the on-stand transport modules 12, excluding the stands 11 from the equipment modules 1. In other words, the process of the present step is to simulate arrangement of the on-stand transport modules 12 or arrangement of the guide rails 122.

### Linking Transport Module Arrangement Step

In the linking transport module arrangement step, the control section 73 simulates connection of the equipment modules 1 via the linking transport module 2. Further, the control section 73 simulates connection of the guide rails 122 of the transport modules in a longer-side direction via the spacer 3. In the present step, the spacer 3a or 3b described above in the variations may be used. Instead of the linking transport module 2, the on-stand transport module 12 protruding in a horizontal direction from the stand may be used.

### Output Section

The output section 74 outputs a result of the simulation in accordance with the control by the control section 73. In an aspect, the output section 74 is constituted by a display device. That is, the output section 74 displays a result of the simulation in, for example, a moving image. This enables who installs the transport system 100 to configure the transport system 100 having each transport module disposed in an optimal position by referring to the display of the output section 74.

The simulation device 7 may simulate the sliding of one or more guide blocks 4, and the control section 73 may transmit a result of the simulation to the controller 6 as an instruction to cause the transport system 100 to actually carry out the simulation. The simulation device 7 may also simulate arrangement of the plurality of transport systems 100.

### Additional Remarks

The present invention is not limited to the embodiments, but can be altered by a skilled person in the art within the scope of the claims. The present invention also encompasses, in its technical scope, any embodiment derived by combining technical means disclosed in differing embodiments.

For example, at least one of the steps carried out by the simulation device 7 described in the above embodiment can be realized by a logic circuit. For example, an integrated circuit in which a logic circuit that functions as each of the control blocks is formed is also encompassed in the scope of the present invention. In addition, the function of each of the control blocks can be realized by, for example, a quantum computer.

Further, at least one of the steps which are carried out by the simulation device 7 described in the foregoing embodiments can be executed by artificial intelligence (AI). In this case, the AI may be operated by the control device, or alternatively operated by another device (e.g., an edge computer or a cloud server, etc.).

### Reference Signs List

1 Equipment module
2 Linking transport module (second transport module)
3, 3a, 3b Spacer
4 Guide block
5 Driver (first driver, second driver)
6 Controller
7 Simulation device
11 Stand
12 On-stand transport module (first transport module)
31, 31a Spacer body
32 Protrusion (engaged part)
34 Rolling element
34a Load-bearing rolling element
34b Load-free rolling element
35 End cap
38 Impregnation part
71 Input section
72 Storage section
73 Control section
74 Output section
100 Transport system
121 Body
121a Stand
121b Fixing part
122 Guide rail
122a Recess (engaging part)
123 Sensor array
123a Support member
123b Sensor
124 Coil (end coil)

1. An equipment module comprising a stand that supports one or more transport modules and that is repositionable, wherein:
the stand supports the one or more transport modules so that part of at least one transport module of the one or more transport modules protrudes from the stand in a horizontal direction; and
the equipment module is connected to an adjacent equipment module via the at least one transport module protruding from the stand in the horizontal direction.

2. The equipment module according to claim 1, comprising the stand and a first transport module supported by the stand that is single,
the equipment module being connected to the adjacent equipment module via a second transport module provided in a position bridging between the first transport module and a first transport module included in the adjacent equipment module.

3. The equipment module according to claim 2, wherein the first transport module and the second transport module are connected via a spacer that is attachable and detachable while the transport modules are in a fixed state.

4. The equipment module according to claim 3, wherein
the spacer has:
a first face provided so as to be directed in a direction from an end part of a first face of a guide rail included in the first transport module to an end part of a first face of a guide rail included in the second transport module; and
a second face provided so as to be directed in a direction from an end part of a second face of the guide rail included in the first transport module to an end part of a second face of the guide rail included in the second transport module, and
the first face and the second face of each of the spacer, the guide rail included in the first transport module, and the guide rail included in the second transport module are opposite faces thereof.

5. The equipment module according to claim 3, wherein in a state in which the spacer is attached between the first transport module and the second transport module, inclination of the spacer changes in any one direction within a specific range when a guide block slides on the spacer.

6. The spacer according to claim 3, comprising a plurality of components into which the spacer is dividable in a direction in which a guide block slides.

7. The equipment module according to claim 2, wherein:
the first transport module and the second transport module are of a moving magnet type and each include a guide rail, one or more coils provided alongside the guide rail, and one or more sensors configured to read a scale included in a guide block that slides on the guide rail;
among the one or more coils included in the first transport module, an end coil that faces a side of the second transport module is associated with a first driver configured to control power supplied to the end coil;
among the one or more coils included in the second transport module, an end coil that faces a side of the first transport module is associated with a second driver configured to control power supplied to the end coil; and
information on a position or velocity of the guide block is transmitted from the first driver to the second driver or is transmitted from the second driver to the first driver.

8. The equipment module according to claim 1, wherein the stand is provided with a device configured to carry out a predetermined process or measurement on a workpiece transported by the one or more transport modules.

9. A transport module connecting equipment modules that each include a stand which is repositionable and that include on-stand transport modules each supported by the stand that is single,
the transport module being provided in a position bridging between the on-stand transport modules included in the equipment modules.

10. A non-transitory computer-readable storage medium storing therein a program for causing a computer to carry out:
a first step of simulating arrangement of the equipment module according to claim 1; and
a second step of simulating connection of the equipment modules via the at least one transport module protruding from the stand in the horizontal direction.
